(19) United States
(12) Patent Application Publication
(10) Pub. No.: US 2018/0216016 A1
(43) Pub. Date: Aug. 2, 2018

(54) SYSTEM AND METHOD OF PREDICTIVE ANALYTICS FOR DYNAMIC CONTROL OF A HYDROCARBON REFINING PROCESS

(71) Applicant: GENERAL ELECTRIC COMPANY, Schenectady, NY (US)

(72) Inventors: Steve Theodore BAKAS, Trevose, PA (US); Kantilal Nimeshkumar PATEL, The Woodlands, TX (US); Conrad Keny TERAN, The Woodlands, TX (US)

(21) Appl. No.: 15/748,368

(22) PCT Filed: Jul. 29, 2016
(86) PCT No.: PCT/US2016/044839

§ 371 Date: Jan. 29, 2018

Related U.S. Application Data
(60) Provisional application No. 62/199,605, filed on Jul. 31, 2015.

(51) Int. Cl. C10G 31/08; C10G 7/12; C10G 31/06; C10G 75/04; C10G 75/02

(52) U.S. Cl. CPC C10G 31/08; C10G 7/12; C10G 31/06; C10G 2300/206; C10G 75/02; B01J 2219/00191; C10G 75/04

(57) ABSTRACT

Described herein are systems and methods of dynamically using predictive analytics in control of a hydrocarbon refining process. In one aspect, the method comprises analyzing a hydrocarbon sample, wherein the hydrocarbon sample is representative of an amount of hydrocarbon entering a refining process; developing one or more predictive models of the hydrocarbon refining process for the hydrocarbon entering the refining process based on the analysis of the hydrocarbon sample; and dynamically controlling aspects of the hydrocarbon refining process as the hydrocarbon entering the refining process moves through the refining process based on the one or more predictive models.

### CROSS REFERENCE TO RELATED APPLICATION

This application claims priority to and benefit of U.S. Provisional Patent Application Ser. No. 62/199,605 filed Jul. 31, 2015, which is fully incorporated by reference and made a part hereof.

### BACKGROUND

The majority of hydrocarbons found on earth naturally occur in crude oil, where decomposed organic matter provides an abundance of carbon and hydrogen which, when bonded, can catenate to form seemingly limitless chains. Hydrocarbons can be refined in a refining process to produce products such as gasoline, diesel fuel, paraffin wax, and the like. The refining process can include a tank-farm, a cold preheat train, a desalter, a hot preheat train, a crude heater/furnace, a crude distillation unit, a vacuum unit furnace, a vacuum distillation unit, and downstream processing units such a hydrotreater, a hydrocracker, fluid catalytic cracking (FCC), a visbreaker, a coker, etc.

As noted, desalting is one step in the refining process. Generally, desalting is one of the first operations in the oil refining process. Crude oil that is processed without desalting may be detrimental to the refinery assets, leading to severe corrosion problems. For example, hydrochloric acid may be formed in the refining process, leading to accelerated corrosion. The desalter system removes the majority of salts in the crude oil by injecting water into the system. Because of the higher solubility in water, salts move from the crude oil to the water phase. Thus, desalter systems are typically large gravity settling tanks that provide enough residence time for both the water and the crude oil to settle. Usually density of water is higher than that of oil; hence, water settles at the bottom of the desalter system, and crude oil leaves the unit from the top. Further, the addition of an electrical grid at the top of desalter systems may promote the separation of crude oil at the top and the water to settle at the bottom.

In some cases, the crude oil and water may have a relatively thin interface. However, in practice, during the operation, an emulsion of water in crude oil may be formed as a distinct layer between the water and crude oil. This emulsion band, also referred to as a “rag layer,” can be quite dynamic in position and size. Typically, these emulsion bands can cause oil refiners to run less than optimum wash water rates and low mix valve pressure drops, which reduces its efficiency for salt and sediment removal. Excessive growth of these emulsion bands can shorten the operational lifespan of the electrical grids in the desalter system, thus bringing the entire refinery operations to a halt. Accordingly, it may be important to monitor and control the performance of the desalter system and keep the position and size of the emulsion band under control.

Performance of the desalter may be characterized, for example, based on: percentage salt removal in desalted crude oil relative to that of feed, percentage water removal in desalted crude oil relative to that of feed, and/or percentage oil carry over in brine or desalter water exit stream. Optimal operation of the desalter means very high values of salt and water removal and close to zero value for oil carryover in water. Adjustments may be made during operation of the desalter to improve performance.

Note that efficient operation of the desalter system may be difficult and require an expert with substantial experience to make the right corrective adjustments. The crude oil blend in refineries changes frequently, and when the refineries process a new blend, the operators need to be able to judge performance of the desalter system without direct visibility of the emulsion band (rag layer), to determine effectiveness of the chemical treatment, and to initiate appropriate corrective actions during upset conditions.

Furthermore, other aspects and parameters of the refining process can be controlled and monitored. Currently, for example, samples are taken for a given hydrocarbon blend, sent to a lab for analysis, and then returned. This process can take hours if not days; therefore the hydrocarbon being processed has likely changed from that from which the sample was taken. Therefore, controls being adjusted based on the sample or decisions based on additives to the processing system are based not on the hydrocarbon currently being processed, but on an earlier volume of hydrocarbon. For example, based upon analysis of the hydrocarbon undergoing processing, various additives can be made to the hydrocarbon such as crude stabilizer (CS) dosage demand, emulsion stability and demulsifier (EB) dosage demand, fouling potential and antifoulant (AF) dosage demand, and corrosion related performance and corrosion inhibitor dosage demand during the refinery hydrocarbon processing based on statistical modeling of lab data. Again, currently, these decisions are being made on samples taken hours if not days prior.

Thus, there exists a strong need for a tool available to hydrocarbon refiners that enables them to predict potential problems (emulsion breaking, fouling and corrosion related) associated with processing of a given set of crude oil blend/s proactively before they start or during processing the blend, and optimize or control desalter performance and other aspects of the refining process in a dynamic manner.

Therefore, a system and method that dynamically uses predictive analytics in control of a hydrocarbon refining process is desirable.

### BRIEF DESCRIPTION

Disclosed herein are systems and methods of dynamically using predictive analytics in control of a hydrocarbon refining process.

In one aspect, a method of dynamically using predictive analytics in control of a hydrocarbon refining process is described. This method comprises analyzing a hydrocarbon sample, wherein the hydrocarbon sample is representative of an amount of hydrocarbon entering a refining process; developing one or more predictive models of the hydrocarbon refining process for the hydrocarbon entering the refining process based on the analysis of the hydrocarbon sample; and dynamically controlling aspects of the hydrocarbon refining process as the hydrocarbon entering the refining process moves through the refining process based on the one or more predictive models.

In another aspect, a system for dynamically using predictive analytics in control of a hydrocarbon refining process is described. This system can be comprised of a memory, wherein the memory stores computer-readable instructions; and a processor communicatively coupled with the memory, wherein the processor executes the computer-readable instructions stored on the memory. The computer-readable instructions cause the processor to receive an analysis of a hydrocarbon sample, wherein the hydrocarbon sample is representative of an amount of hydrocarbon entering a refining process; develop one or more predictive models of the hydrocarbon refining process for the hydrocarbon entering the refining process based on the analysis of the hydrocarbon sample; and dynamically control aspects of the hydrocarbon refining process as the hydrocarbon entering the refining process moves through the refining process based on the one or more predictive models.

Yet another aspect comprises a non-transitory, computer-readable medium storing instructions that, when executed by a computer processor, cause the computer processor to perform a method useful in a crude oil refinement process, the method comprising: receiving an analysis of a hydrocarbon sample, wherein the hydrocarbon sample is representative of an amount of hydrocarbon entering a refining process; developing one or more predictive models of the hydrocarbon refining process for the hydrocarbon entering the refining process based on the analysis of the hydrocarbon sample; and dynamically control aspects of the hydrocarbon refining process as the hydrocarbon entering the refining process moves through the refining process based on the one or more predictive models.

In one aspect, analyzing the hydrocarbon sample comprises obtaining a fingerprint of the hydrocarbon sample. The fingerprint of the hydrocarbon sample may be obtained using spectroscopy such as infrared spectroscopy, near-infrared spectroscopy, and nuclear magnetic resonance spectroscopy, and the like.

In one aspect, developing one or more predictive models of the hydrocarbon refining process for the hydrocarbon entering the refining process based on the analysis of the hydrocarbon sample comprises developing one or more predictive models based on the fingerprint that estimate or predict one or more of density, viscosity, total acid number (TAN), percent saturates, percent asphaltenes, percent resins, percent aromatics, asphaltene stability, crude stabilizer (CS) dosage demand, emulsion stability and demulsifier (EB) dosage demand, fouling potential and antifoulant (AF) dosage demand, and corrosion related performance and corrosion inhibitor dosage demand during the hydrocarbon refining process. The one or more predictive models may comprise one or more of a crude markers model, a crude compatibility/instability model, an emulsion tendency model, and a fouling potential model. In one aspect, a crude stabilizer dose is determined from the instability model. The crude stabilizer dose may be added to a hydrocarbon storage tank farm that holds the hydrocarbon entering the refining process. The crude stabilizer dose may comprise the injection of one or more stabilizing chemicals to the crude in the incoming transport system or to crude storage tanks.

In one aspect, an emulsion breaker dose can be determined from the emulsion tendency model. The emulsion breaker dose may be added to a hydrocarbon storage tank farm that holds the hydrocarbon entering the refining process. The emulsion breaker dose may comprise the injection of one or more demulsification and wetting agents chemicals to the crude in the incoming transport system and/or to crude in tankage, and/or to the water wash and to the desalter.

In one aspect, an anti-fouling dose can be determined from the fouling potential model. The anti-fouling dose may be added to a hot preheat train after desalting of the refining process. The anti-fouling dose may comprise the injection of dispersants, stabilizers, polymerization inhibitors, metal coordinators, and the like.

In one aspect, dynamically controlling aspects of the hydrocarbon refining process as the hydrocarbon entering the refining process moves through the refining process based on the one or more predictive models may comprise providing advisory information from the one or more predictive models to person regarding the operation of the refining process or a portion of the refining process. In another aspect, dynamically controlling aspects of the crude refining process as the hydrocarbon entering the refining process moves through the refining process based on the one or more predictive models may comprise providing data from the one or more predictive models to a dynamic desalter model.

In one aspect, the dynamic desalter model predicts performance of a desalter that comprises a portion of the refining process. The dynamic desalter model may be used to control a desalter that comprises a portion of the refining process.

In one aspect, one or more sensors are used that monitor the refining process, wherein the processor receives process data from the refining process as the hydrocarbon moves through the refining process. The process data may be used to refine and update the developed one or more predictive models of the hydrocarbon refining process for the hydrocarbon entering the refining process based on the analysis of the hydrocarbon sample. Aspects of the hydrocarbon refining process as the hydrocarbon entering the refining process moves through the refining process may be dynamically controlled based on the refined and updated one or more predictive models. Dynamically controlling aspects of the hydrocarbon refining process as the hydrocarbon entering the refining process moves through the refining process based on the one or more predictive models may comprise dynamically controlling the hydrocarbon refining process to mitigate creation of hydrochloric acid in the refining process. The refining process may comprise a tank farm, a cold preheat train, a desalter, a hot preheat train, a crude heater/furnace, a crude distillation unit, a vacuum unit furnace, a vacuum distillation unit, and downstream processing units. In one aspect, the hydrocarbon comprises crude oil.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### DRAWINGS

The accompanying drawings, which are incorporated in and constitute a part of this specification, illustrate embodiments and together with the description, serve to explain the principles of the methods and systems:

FIG. 1A is an overview of a refining process and a system for controlling and monitoring the process;

FIG. 1B is a flowchart illustrating a method of dynamically using predictive analytics in control of a hydrocarbon refining process;

FIG. 1C is a block schematic diagram of a desalter system in accordance with some embodiments;

FIG. 2 illustrates a method according to some embodiments;

FIG. 3 illustrates the inner operation of a desalter vessel in accordance with some embodiments;

FIG. 4 is a high level architecture for a mechanistic, physics-based desalter model according to some embodiments;

FIG. 5 is a block diagram of a control system in accordance with some embodiments;

FIG. 6 is block diagram of a platform according to some embodiments of the present invention;

FIG. 7 is a tabular portion of a desalter input database according to some embodiments; and

FIG. 8 illustrates a user display for a desalter system in accordance with some embodiments.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes¬from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

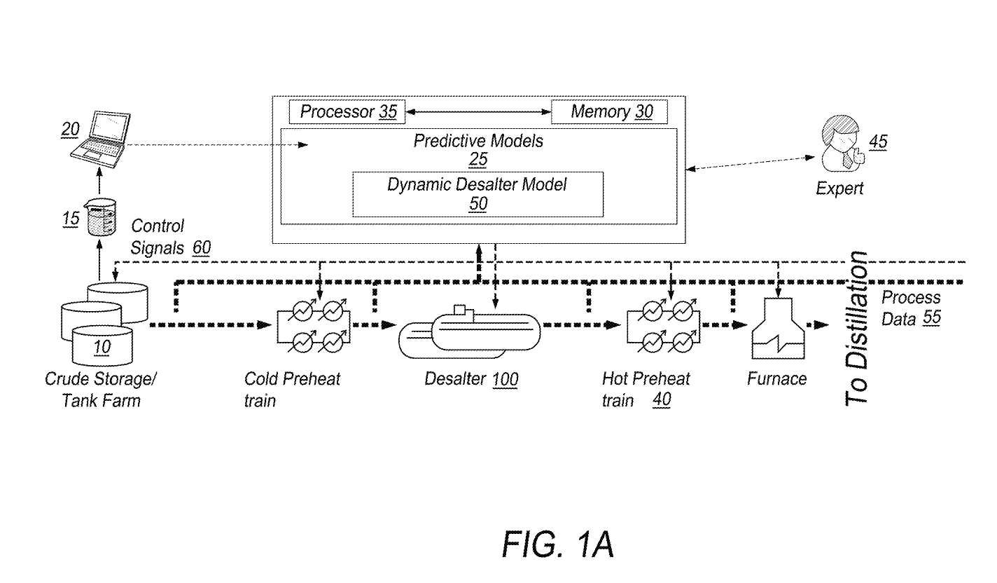

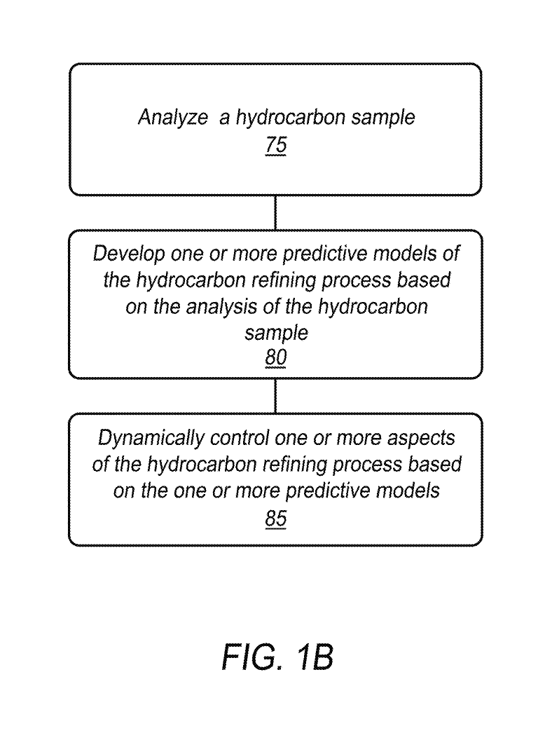

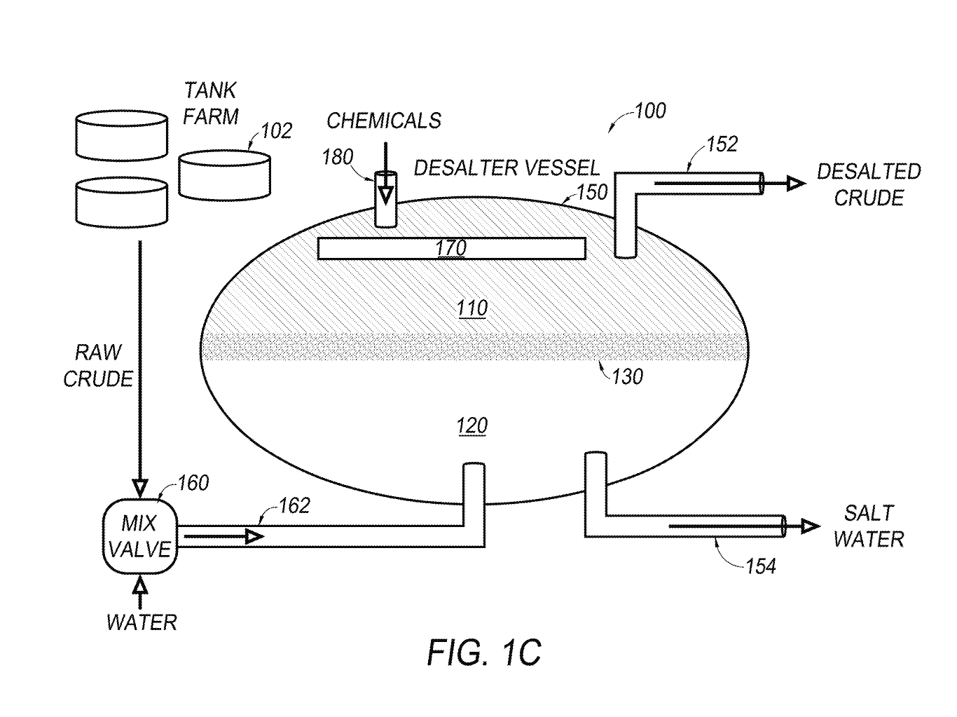

FIG. 1A is a simplified overview diagram of a portion of a hydrocarbon refining process and a system for controlling and monitoring the process. The hydrocarbon refining process can include, for example, a tank farm, a cold preheat train, a desalter, a hot preheat train, a crude heater/furnace, a crude distillation unit, a vacuum unit furnace, a vacuum distillation unit, and downstream processing units.

The disclosed systems and methods enable dynamically using predictive analytics in control of a hydrocarbon refining process by analyzing a hydrocarbon sample, wherein the hydrocarbon sample is representative of an amount of hydrocarbon entering a refining process; providing the analysis of the hydrocarbon to a processor, wherein the processor develops one or more predictive models of the hydrocarbon refining process for the hydrocarbon entering the refining process based on the analysis of the hydrocarbon sample; and dynamically controlling aspects of the hydrocarbon refining process as the hydrocarbon entering the refining process moves through the refining process based on the one or more predictive models.

As shown in FIG. 1A, a hydrocarbon such as crude oil is stored in a tank farm 10. From the tank or as the hydrocarbon is being introduced to the tank farm 10, a sample 15 of the hydrocarbon is taken. The hydrocarbon sample is representative of an amount of hydrocarbon entering a refining process. An analysis of the hydrocarbon is performed. This analysis is performed on the sample 15 using, for example, an analyzer 20. Generally the analyzer 20 is an automated device that includes a reservoir for receiving the sample 15, one or more transducers (not shown) for interfacing with the sample, and a processor that executes software for performing the analysis. In one aspect, the analyzer 20 obtains a fingerprint of the hydrocarbon sample. For example, the analyzer 20 may obtain the fingerprint of the sample using spectroscopy, such as one or more of infrared spectroscopy, near-infrared spectroscopy, and nuclear magnetic resonance spectroscopy.

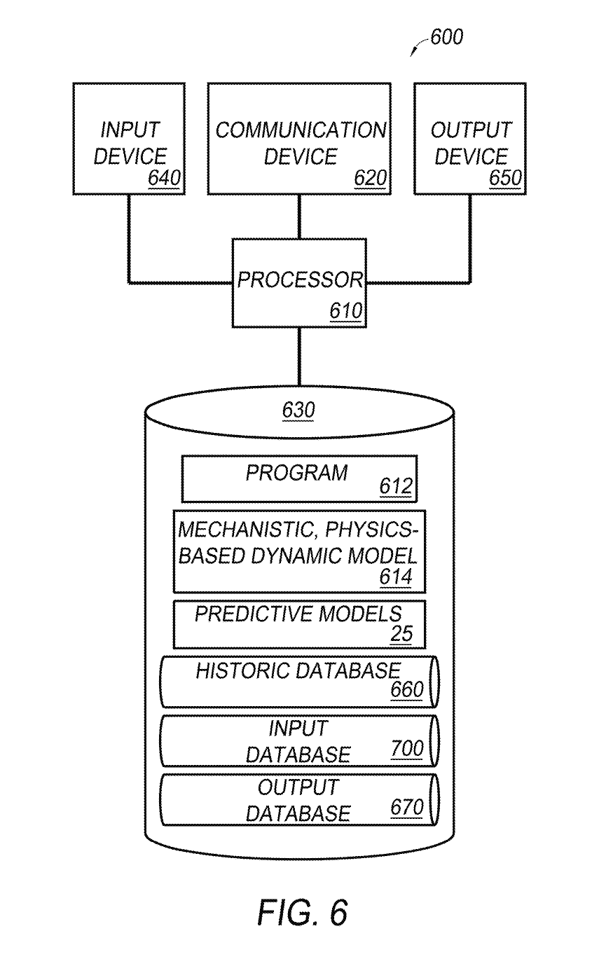

The information obtained by the analysis of the hydrocarbon sample 15 is provided to one or more predictive models 25. Generally, the predictive models 25 comprise software instructions residing in a memory 30 that are executed by a processor 35. The processor 35 may be the same processor as used by the analyzer 20, or it may be a different processor. The processor and memory are described in further detail with reference to FIG. 6, herein. In one aspect, at least portions of the processor 35 and memory 30 can reside in a cloud environment. Data may be transmitted wirelessly from the refining process, including the analyzer, 20 to the cloud environment. Similarly, control signals may be transmitted wirelessly from the cloud environment to actuators associated with the refining process.

The predictive models 25 are developed based on the information obtained by the analysis of the hydrocarbon sample 15. The developed predictive models can be used to estimate or predict crude markers such as density, viscosity, total acid number (TAN), percent saturates, percent asphaltenes, percent resins, percent aromatics, asphaltene stability, relative instability index, colloidal instability index, crude stabilizer (CS) dosage demand, emulsification tendency and demulsifier (EB) dosage demand, fouling potential and antifoulant (AF) dosage demand, corrosion related performance and corrosion inhibitor dosage demand, and the like during the hydrocarbon refining process.

In various aspects, the one or more predictive models 25 can comprise one or more of a crude markers model (crude markers are defined as parameters that describe crude functionalities related to its composition and fluid behavior), a crude compatibility/instability model, an emulsification tendency model, and a fouling potential model. For example, a crude stabilizer dose can be determined from the instability model. Generally, the crude stabilizer dose is added to a hydrocarbon storage tank farm 10 that holds the hydrocarbon entering the refining process, though the crude stabilizer dose may be added at other points in the refining process as well. The crude stabilizer dose is determined by the crude compatibility/stability model and can comprise, for example, the injection of one or more stabilizing chemicals to the crude in the incoming transport system or to crude storage tanks. In another example, an emulsion breaker dose can be determined from the emulsion tendency model. Generally, the emulsion breaker dose is added to a hydrocarbon storage tank farm 10 that holds the hydrocarbon entering the refining process, though the emulsion breaker dose may be added at other points in the refining process as well. The emulsion breaker dose can comprise, for example, the injection of one or more demulsification and wetting agents chemicals. In yet another example, an antifoulant dose can be determined from the fouling potential model. Generally, the fouling potential model can be added to a hot preheat train 40 after desalting, though the antifoulant dose may be added at other points in the refining process as well. The-antifoulant dose can comprise, for example, the injection of dispersants, stabilizers, polymerization inhibitors and metal coordinators.

In one aspect, dynamically controlling aspects of the hydrocarbon refining process as the hydrocarbon entering the refining process moves through the refining process based on the one or more predictive models 25 can comprise providing advisory information from the one or more predictive models 25 to a person 45 regarding the operation of the refining process or a portion of the refining process. Based on the information provided, the person 40 can make operational decisions about the refining process. Furthermore, the person 45 can provide inputs and adjustments to the predictive models 25 to vary control and/or monitoring parameters of the described system. In one aspect, dynamically controlling aspects of the crude refining process as the hydrocarbon entering the refining process moves through the refining process based on the one or more predictive models 25 can comprise providing data from the one or more predictive models 25 or from the analyzer 20 to a dynamic desalter model 50, such as that described herein. In one aspect, the dynamic desalter model 50 predicts performance of a desalter system 100 that comprises a portion of the refining process.

As shown in FIG. 1A, the predictive models 25 can also receive process data 55 from the refining process. Generally, process data is received from sensors that monitor the refining process. Process data 55 can be used to refine, revise and improve the accuracy of the predictive models 25. Such process data 55 can be, for example, various pressures, temperatures, flow rates, levels, volumes, weights, efficiencies, voltages, currents, and the like of various components of the refining process. For example, process data from the desalter system 100 can indicate the composition of the emulsion in the desalter system 100 as well as that entering and exiting the desalter system 100, as well as emulsion levels and location of the rag layer within the desalter system 100. Such measured process data 55 can be compared to the data generated by the predictive models 25 to refine and update the predictive models 25 of the hydrocarbon refining process for the hydrocarbon entering the refining process based on the analysis of the hydrocarbon sample. This can result in greater accuracy and better control the refining process. For example, aspects of the hydrocarbon refining process as the hydrocarbon entering the refining process moves through the refining process can be dynamically controlled and updated based on the refined and updated one or more predictive models 25.

As noted herein, the predictive models 25 can be used for control of the refining process. As shown in FIG. 1A, control signals 60 can be sent from the predictive models 25 to various components of the refining process. Such control signals can be used to raise or lower temperatures or pressures, adjust valves, and even to modify the hydrocarbon by adding determined amounts of additives, as described herein. For example, an aim of the predictive models 25 may be to dynamically control the hydrocarbon refining process to mitigate creation of hydrochloric acid in the refining process. Generally, hydrochloric acid can cause unwanted corrosion in the refining process.

FIG. 1B is a flowchart illustrating a method of dynamically using predictive analytics in control of a hydrocarbon refining process. At 75, a hydrocarbon sample is analyzed. The hydrocarbon sample is representative of an amount of hydrocarbon entering a refining process. Analyzing the hydrocarbon sample can comprise obtaining a fingerprint of the hydrocarbon sample. In one aspect, the fingerprint of the hydrocarbon sample is obtained using spectroscopy such as one or more of infrared spectroscopy, near-infrared spectroscopy, nuclear magnetic resonance spectroscopy, and the like.

At 80, one or more predictive models of the hydrocarbon refining process are developed for the hydrocarbon entering the refining process based on the analysis of the hydrocarbon sample. This can comprise developing one or more predictive models based on the fingerprint that estimate or predict one or more crude markers such as density, viscosity, total acid number (TAN), percent saturates, percent asphaltenes, percent resins, percent aromatics, asphaltene stability, relative instability index, colloidal instability index, crude stabilizer (CS) dosage demand, emulsification tendency and demulsifier (EB) dosage demand, fouling potential and antifoulant (AF) dosage demand, corrosion related performance and corrosion inhibitor dosage demand, and the like during the hydrocarbon refining process.

The one or more predictive models comprise one or more of a crude markers model (crude markers are defined as parameters that describe crude functionalities related to its composition and fluid behavior), a crude compatibility/instability model, an emulsification tendency model, and a fouling potential model, wherein a crude stabilizer dose can be determined from the crude compatibility/instability model, an emulsion breaker dose can be determined from the emulsion tendency model, and an antifoulant dose can be determined from the fouling potential model.

At 85, aspects of the hydrocarbon refining process are dynamically controlled as the hydrocarbon entering the refining process moves through the refining process based on the one or more predictive models. In one aspect, advisory information can be provided from the one or more predictive models to person regarding the operation of the refining process or a portion of the refining process. Alternatively or optionally, data can be provided from the one or more predictive models to a dynamic desalter model, wherein the dynamic desalter model predicts performance of a desalter that comprises a portion of the refining process. Such a dynamic desalter model may control the desalter that comprises a portion of the refining process.

Optionally, process data may be received by the predictive models as the hydrocarbon moves through the refining process. The process data may be used to refine and update the developed one or more predictive models of the hydrocarbon refining process for the hydrocarbon entering the refining process based on the analysis of the hydrocarbon sample. The refining process can be dynamically controlled based on the refined and updated one or more predictive models.

In the process of FIG. 1B, one or more of the process steps can be performed by at least one processor.

Described below is a crude oil refining process in which embodiments of predictive analytical modeling, described above, can be employed. In particular, the predictive analytic models 25 described above can interface with a dynamic desalter model 50 for better control and less variability of the refining process. FIG. 1C is a block schematic diagram of a desalter system 100 that can be used in the refining process described above, in accordance with some embodiments. The system includes a desalter vessel 150 that receives a combination of raw crude oil (e.g., from a tank farm 102) and water from a mix valve 160 via an input pipe 162. The desalter vessel 150 provides desalted crude oil via a first output pipe 152 and salt water or brine via a second output pipe 154. A chemical input pipe 180 and/or an electrified grid 170 may facilitate separation within the desalter vessel 150 of an oil region 110 and a water region 120 that interface at a rag layer 130. The geometry of the vessel 150 and associated pipes 162, 152, 154, 180, the chemicals injected into the vessel, the power applied to the electrified grid may all impact operation of the system.

Moreover, variation in crude oil composition and properties may cause operational issues with the system 100, which in turn may impact downstream operation and reliability of a refinery. Note that many different factors, both physical and chemical, may interact to govern the desalter vessel 150 behavior in the presence of crude variations. These factors, and their interaction, are complex and may result in a limited ability to achieve robust and consistent operation of the system. However, as noted above, dynamic analysis of the crude oil composition and properties can be used to dynamically control the chemical and physical factors for more achieve robust and consistent operation of the system. Typically, a desalter vessel 150 is one of the least instrumented and automated units in a refinery. Experienced operators manually make operational decisions based on limited information and limited knowledge of the overall desalter operation. Embodiments described herein may facilitate an automatic generation of appropriate advisory data to improve performance of the desalter system 100.

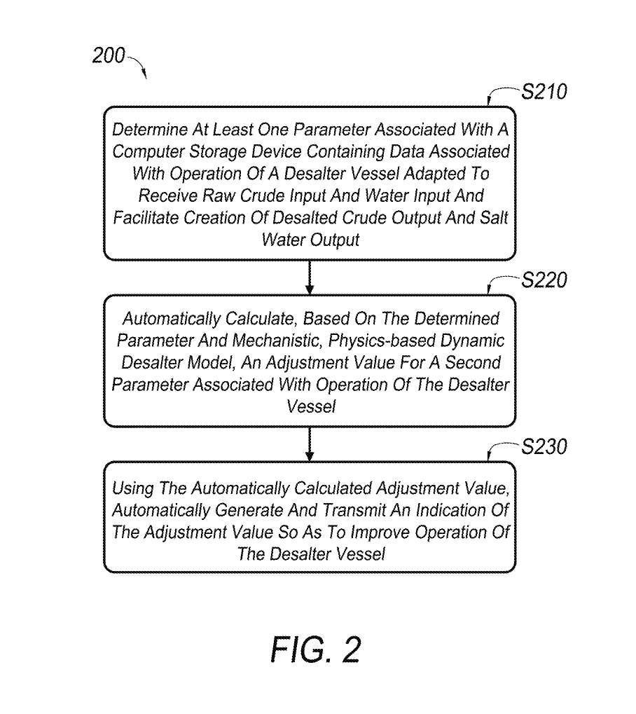

For example, FIG. 2 is a flow chart of a method 200 in accordance with some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, at least one parameter within a computer storage device, such as a computer store, may be “automatically” determined. As used herein, a process may be “automatic” if it can be performed with little or no human intervention. The computer storage device may, for example, contain data associated with the operation of a desalter vessel adapted to receive a raw crude input and a water input and facilitate creation of a desalted crude output and a salt water output. The determined parameter might be associated with one or more of: (i) a temperature, (ii) a pressure, (iii) an amount of water in the desalted crude output, (iv) an amount of salt in the desalted crude output, and/or (v) an amount of crude in the salt water output. The determined parameter might also be associated with at least one of: (i) an electric grid, (ii) a density, (iii) a viscosity, (iv) emulsion characteristics, (v) an inflow rate, (vi) an outflow rate, and/or (vii) a rag emulsion layer.

According to some embodiments, the determined parameter is associated with an amount of a chemical, an Emulsion Breaker (“EB”), and/or a Reverse Emulsion Breaker (“REB”). Note that the adjustment value might be associated with a chemical, an electric grid, an inflow rate, and/or an outflow rate. By ways examples only, the chemical might be associated with a demulsifier chemical such as oxyalkylated amines, alkylaryl sulfonic acid and salts thereof, oxyalkylated phenolic resins, polymeric amines, glycol resin esters, polyoxyalkylated glycol esters, fatty acid esters, oxyalkylated polyols, low molecular weight oxyalkylated resins, bisphenol glycol ethers and esters, and/or polyoxyalkylene glycols.

At S220, the system may calculate, based on the determined parameter and a physics-based dynamic desalter model, an adjustment value for a second parameter associated with operation of the desalter vessel. According to some embodiments, the calculation of S220 is performed automatically. At S230, the system may use the automatically calculated adjustment value to automatically generate and transmit an indication of the adjustment value so as to improve operation of the desalter vessel. Note that the mechanistic, physics-based dynamic desalter model might incorporate physical properties of the crude oil mixture feeding the unit, wash water and any recycle fluids, including slop, geometry of desalter vessel, water droplet size, water droplet distribution, crude oil droplet size, crude oil droplet distribution, droplet coalescence, hydrodynamics, settled solids, a rag emulsion layer, and/or a mixing valve model. Some, or all, of this information may be provided to the physics-based dynamic desalter model from the predictive models 25 described herein.

In some embodiments, the mechanistic, physics-based dynamic desalter mode may include a basic model with coalescence abilities that have been validated with batch separation literature data. Moreover, the model may have augmented capabilities, such as improved electro-coalescence, series configuration, multiple phases in electric grids, dual port mixing valve, salt, filterable solids, asphaltene precipitation, and/or mud wash consideration. Further, the model may take into account physical properties and composition of the crude oil feed to the unit and chemical additions provided to the physics-based dynamic desalter model from the predictive models 25 described herein, which are designed to enhance the demulsification processes occurring in the desalter

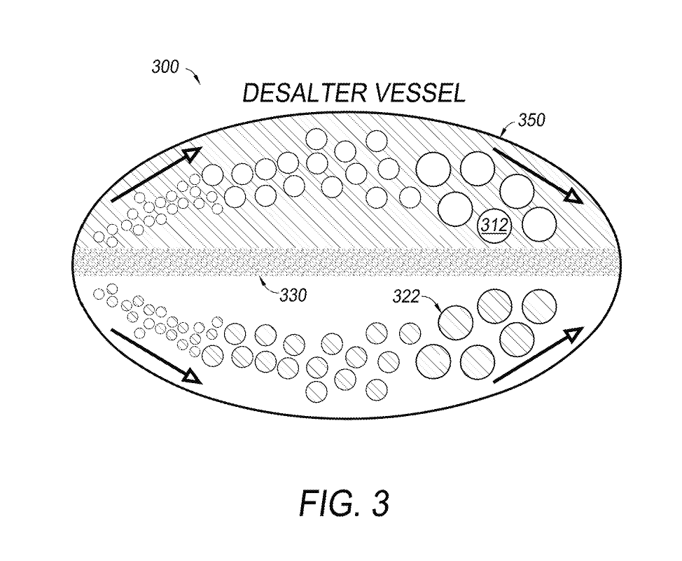

FIG. 3 illustrates the inner operation of a desalter vessel 300 in accordance with some embodiments. The desalter vessel 300 includes an oil region having some water droplets 312 (shown white in FIG. 3) and a water region having some oil droplets 322 (shown crosshatched in FIG. 3). Note that the average size of the droplets 312, 322 might increase over time, causing them to migrate (fall or rise) to the rag layer 330. Some inputs associated with the operation of the desalter vessel 300 include desalter design geometry and configuration, oil-water mixture in feed (% water), in/out flow rates—residence times, water droplet size distribution in feed and desalter, coalescence of droplets (both general and electro), hydrodynamics—internal oil/water flows, phase inversion, and/or solids settling (reduced residence time). Additional inputs/factors may include emulsion (rag) formation and stability, impact on separation, the effect of crude properties, the effect of water properties, and/or the effect of chemicals (EB, REB). Some outputs associated with the operation of the desalter vessel 300 include amount oil in brine, water, salt and solids in desalted oil, oil/water profile along desalter height, rag layer location and width, and/or transient dynamics—residence time.

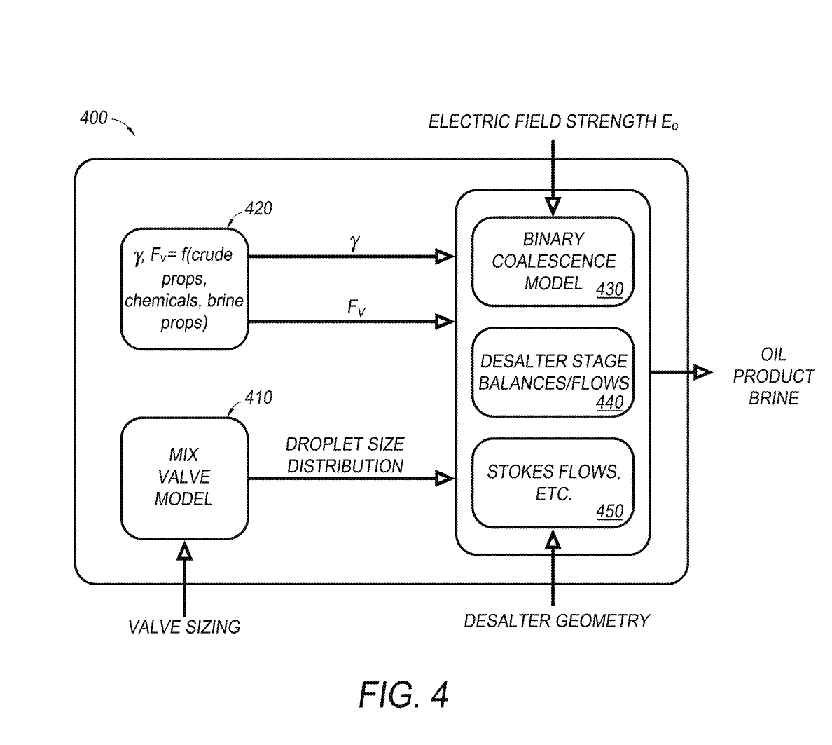

FIG. 4 is a high level architecture for a mechanistic, physics-based desalter model 400 according to some embodiments. The model 400 includes a mix valve model 410 that receives valve sizing data and a function ƒ 420 that takes into account crude oil properties, chemicals, and brine water properties. The model 400 may further receive the following inputs:
F_{feed+water}
μₒᵢₗ
ρₒᵢₗ
ρ_{water}

According to some embodiments, the model 400 also includes a binary coalescence model 430, desalter stage balances and flows 440, and a Stokes flow component 450 to generate predicted oil product and brine output based on an electric field strength E_{O} and desalter geometry. Note that a net coalescence rate for droplets might be represented by a collision frequency multiplied by a collision efficiency for the droplets. Moreover, the rate may comprise a function f (desalter conditions, electric field, emulsion droplet size distribution, crude properties and composition, water properties, chemical demulsifier type and concentration). As a result, smaller droplets may disappear (due to coalescence to larger ones). With respect to the binary coalescence model 430, a dynamic volume of balance on a bubble k in section i of a desalter vessel might be represented as follows:

$${V}_{i} \frac{{dx}_{W , i}^{k}}{dt} = {F}_{fi} {x}_{FW}^{k} + {f}_{W , i + 1}^{k} - {f}_{W , i}^{k} [ - {F}_{B} {x}_{W , 1}^{k} ] + ( 1 - {β}_{i} ) {R}_{CW , i}^{k}$$

Some embodiments described herein may use first principles to capture important cause and effect relationships to build a dynamic model 400 of a refinery desalter, which can predict both steady-state and dynamic behavior. The model 400 may capture effects of crude and water properties, chemical dosage and type, desalter operating conditions, including upstream mixing valve, electro- and general-coalescence, and/or hydrodynamic data for oil-water separation within a vessel. The model 400 may predict behavior of an oil-water profile along vessel height, oil/water droplet size distribution, water level, rag/emulsion location and size inside the vessel, solids balance and accumulation, and/or asphaltene precipitation and accumulation. It may also provide values for key performance indicators associated with product streams, both the desalted crude and the effluent brine, giving the oil/water content, salt content/removal, solids content and asphaltene content. The model 400 might be configured for different types of commercial and pilot-scale desalters for both single and multi-stage with different flow configurations of raw, recycled crude, fresh and recycled wash water, mud wash, etc. The model 400 may also be configured for bench-scale experimental setups.

The model 400 might be used as a basis for offline troubleshooting, what-if scenario simulations, selection of crude oils or crude oil blends for feeding to the refinery, model-based estimation of key performance indicators, advisory controls for chemical dosing and operating conditions. According to some embodiments, the model 400 may be used for model-based control and optimization of a desalter. The model 400 may also be used for online detection and diagnosis of abnormal conditions and faults as well as to optimize design of a desalter unit.

The mechanistic, physics-based model 400 with fundamental differential and algebraic equations may describe key cause and effect relationships and their interaction to describe the overall steady-state/dynamic input/output behavior. The physics-based model 400 may be coupled with an empirical model for the effect of key crude oil and chemicals properties on the coalescence and settling processes occurring in the desalter. The model 400 may have one or more adjustable parameters for each cause-effect relationship that can be fine-tuned based on operation data to improve site-specific accuracy and adaptation over time. The model 400 may be implemented as a computer program to efficiently calculate the dynamic and steady-state behavior, and predict key performance indicators (such as level, rag/emulsion layer location and height, and desalted crude/brine properties)) as one or more inputs are varied.

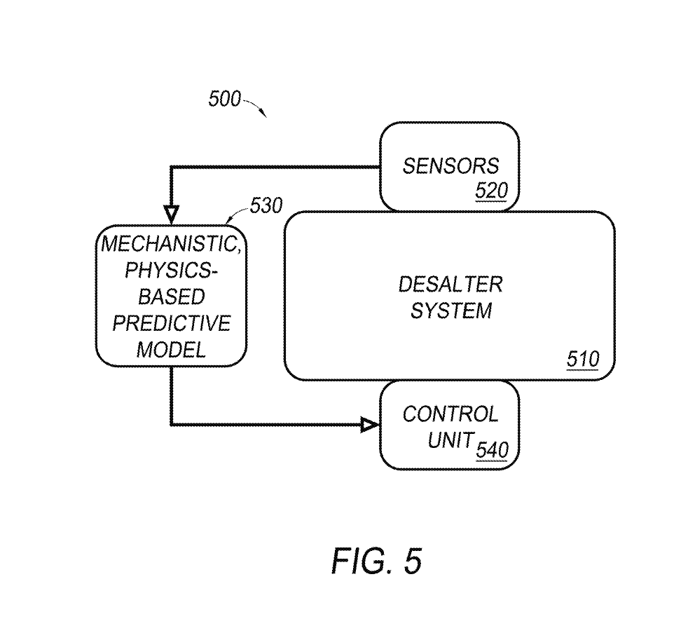

FIG. 5 is a block diagram of a control system 500 in accordance with some embodiments. The system 500 includes a desalter system 510 monitored by one or more sensors 520. Data from the sensors 520 is fed to a mechanistic, physics-based predictive model 530 that analyzes the data and provides an output to a control unit 540 to improve operation of the desalter system 510 in substantially real time. According to some embodiments, the system 100 may be associated with a multi-stage crude oil refinement process having a plurality of desalter vessels. Note that the model 530 may be used in a nonlinear model-based multivariable control algorithm to initially automate the control of chemical dosing, and provide advisory control for other control inputs (e.g. mix valve, flow rates, electric grid). A model-based diagnostics solution may be developed using a combination of model-based estimation algorithms, hypothesis testing and pattern matching to detect and isolate faults like sensor faults from abnormal conditions in the crude and/or the desalter system 540. According to some embodiments, the automatically calculated adjustment value is associated with a dual ported mix value for the desalter vessel. Moreover, the mechanistic, physics-based dynamic desalter model 530 might comprises a predictive model that accounts for non-ideal crude oil and water properties and emulsion characteristics.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The embodiments described herein may be implemented using any number of different hardware configurations. For example, FIG. 6 illustrates a platform 600 that may be, for example, associated with the system of FIGS. 1A and 1C and the methods of FIG. 1B and FIG. 2. The platform 600 comprises a processor 610, such as one or more commercially available Central Processing Units (CPUs) in the form of one-chip microprocessors, coupled to a communication device 620 configured to communicate via a communication network (not shown in FIG. 6). The communication device 620 may be used to communicate, for example, with one or more remote requestor devices, weather reporting services, an analyzer 20, and the like. The platform 600 may further include an input device 640 (e.g., a mouse and/or keyboard to enter information about model algorithms) and an output device 650 (e.g., to output reports regarding desalting operations, operation of the refining process, and the like).

The processor 610 also communicates with a storage device 630. The storage device 630 may comprise any appropriate information storage device, including combinations of magnetic storage devices (e.g., a hard disk drive), optical storage devices, mobile telephones, and/or semiconductor memory devices. The storage device 630 stores a program 612 and/or a desalting model or application 614 and/or predictive models 25 for controlling the processor 610. The processor 610 performs instructions of the programs 612, 614, 25 and thereby operates in accordance with any of the embodiments described herein. For example, the processor 610 may receive data associated with the operation of a desalter vessel, adapted to receive a raw crude input and a water input and facilitate creation of a desalted crude output and a salt water output. The processor 610 may automatically determine at least one parameter within the computer store. The processor 610 may then automatically calculate, based on the determined parameter and a physics-based dynamic desalter model, an adjustment value for a second parameter associated with operation of the desalter vessel. Using the automatically calculated adjustment value, the processor may automatically generate and transmit an indication of the adjustment value (e.g., via the communication device 620) so as to improve operation of the desalter vessel. Similarly, the processor may execute computer-readable instructions stored on the memory 630, the computer-readable instructions causing the processor 610 to receive an analysis of a crude oil sample, wherein the crude oil sample is representative of an amount of crude oil entering a refining process; develop one or more predictive models of the crude oil refining process for the crude oil entering the refining process based on the analysis of the crude oil sample; and dynamically control aspects of the crude oil refining process as the crude oil entering the refining process moves through the refining process based on the one or more predictive models.

The programs 612, 614, 25 may be stored in a compressed, uncompiled and/or encrypted format. The programs 612, 614, 25 may furthermore include other program elements, such as an operating system, a database management system, and/or device drivers used by the processor 610 to interface with peripheral devices.

As used herein, information may be “received” by or “transmitted” to, for example: (i) the desalter platform 600 from another device; or (ii) a software application or module within the desalter platform 600 from another software application, module, or any other source.

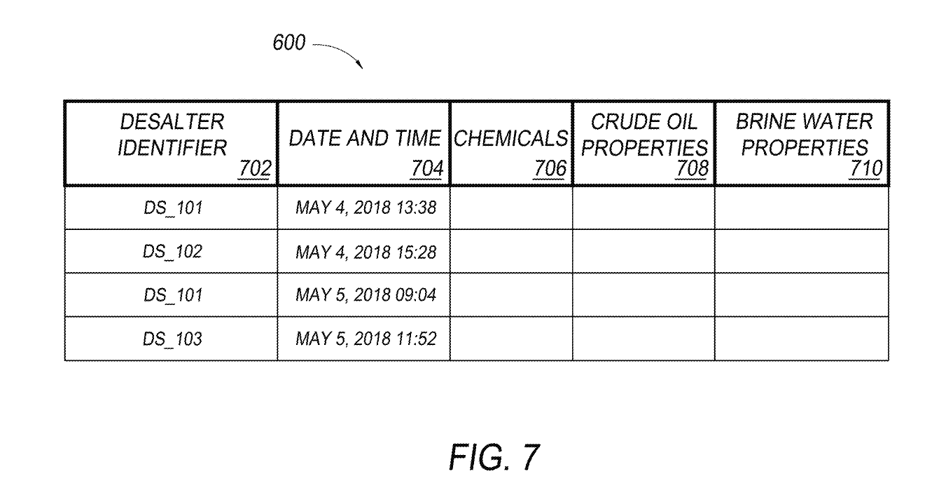

In some embodiments (such as shown in FIG. 6), the storage device 630 includes a historic database 660 (e.g., associated with past desalting operations, results, etc.), an input database 700 (e.g., indicating desalting geometries, settings, etc.) and an output database 670. An example of a database that may be used in connection with the desalter platform 600 will now be described in detail with respect to FIG. 7. Note that the database described herein is only one example, and additional and/or different information may be stored therein. Moreover, various databases might be split or combined in accordance with any of the embodiments described herein. For example, the historic database 660 and/or input database 700 might be combined and/or linked to each other within the dynamic model 614.

Referring to FIG. 7, a table is shown that represents the input database 700 that may be stored at the desalter platform 600 according to some embodiments. The table may include, for example, entries identifying operations of desalter systems. The table may also define fields 702, 704, 706, 708, 710 for each of the entries. The fields 702, 704, 706, 708, 710 may, according to some embodiments, specify: a desalter system identifier 702, a date and time 704, chemicals 706, crude oil properties 708, and brine water properties 710. The input database 700 may be created and updated, for example, based on information electrically received sensors attached to pipelines, etc.

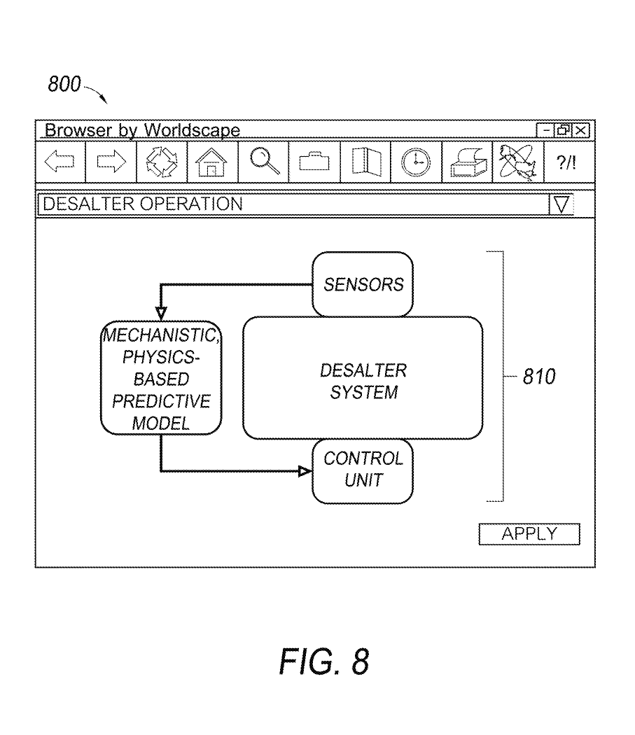

The desalter system identifier 702 may be, for example, a unique alphanumeric code associated with a desalter vessel. Note that another database might store information about the pipes, geometries, etc. of that desalter vessel. The date and time 704 may indicate when the desalting process occurred. The chemicals 706, crude oil properties 708, and brine water properties 710 may be used by a model to improve operation of a desalter vessel. For example, recommended adjustments may be output via a user display 800 for a desalter system such as the one illustrated in FIG. 8 in accordance with some embodiments. The display 800 might include, according to some embodiments graphical 810 and/or numerical indications of how operation of a desalter should be adjusted to improve the performance of the system.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications may be referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method of dynamically using predictive analytics in control of a hydrocarbon refining process comprising:
analyzing a hydrocarbon sample, wherein the hydrocarbon sample is representative of an amount of hydrocarbon entering a refining process;
developing one or more predictive models of the hydrocarbon refining process for the hydrocarbon entering the refining process based on the analysis of the hydrocarbon sample; and
dynamically controlling aspects of the hydrocarbon refining process as the hydrocarbon entering the refining process moves through the refining process based on the one or more predictive models.

2. The method of claim 1, wherein analyzing the hydrocarbon sample comprises obtaining a fingerprint of the hydrocarbon sample using spectroscopy wherein the spectroscopy comprises one or more of infrared spectroscopy, near-infrared spectroscopy, and nuclear magnetic resonance spectroscopy.

3. (canceled)

4. (canceled)

5. The method of claim 2, wherein developing one or more predictive models of the hydrocarbon refining process for the hydrocarbon entering the refining process based on the analysis of the hydrocarbon sample comprises developing one or more predictive models based on the fingerprint that estimate or predict one or more of density, viscosity, total acid number (TAN), percent saturates, percent asphaltenes, percent resins, percent aromatics, asphaltene stability, crude stabilizer (CS) dosage demand, emulsion stability and demulsifier (EB) dosage demand, fouling potential and antifoulant (AF) dosage demand, and corrosion related performance and corrosion inhibitor dosage demand during the hydrocarbon refining process.

6. The method of claim 5, wherein the one or more predictive models comprise one or more of a crude markers model a crude compatibility/instability model, an emulsion tendency model, and a fouling potential model.

7. The method of claim 6, wherein a crude stabilizer dose is determined from the instability model and wherein the crude stabilizer dose comprises an injection of one or more stabilizing chemicals to the crude in an incoming transport system or crude storage tanks or is added to a hydrocarbon storage tank farm that holds the hydrocarbon entering the refining process.

8. (canceled)

9. (canceled)

10. The method of claim 6, wherein an emulsion breaker dose is determined from the emulsion tendency model, wherein the emulsion breaker dose comprises the injection of one or more demulsification and wetting agents chemicals to the crude in the incoming transport system and/or to crude in tankage, and/or to the water wash and to the desalter or wherein the emulsion breaker dose is added to a hydrocarbon storage tank farm that holds the hydrocarbon entering the refining process.

11. (canceled)

12. (canceled)

13. The method of claim 6, wherein an anti-fouling dose is determined from the fouling potential model, wherein the antifoulant dose comprises the injection of dispersants, stabilizers, polymerization inhibitors and metal coordinators or wherein the antifoulant dose is added to a hot preheat train after desalting of the refining process.

14. (canceled)

15. (canceled)

16. The method of claim 1, wherein dynamically controlling aspects of the hydrocarbon refining process as the hydrocarbon entering the refining process moves through the refining process based on the one or more predictive models comprises providing advisory information from the one or more predictive models to person regarding the operation of the refining process or a portion of the refining process.

17. The method of claim 1, wherein dynamically controlling aspects of the crude refining process as the hydrocarbon entering the refining process moves through the refining process based on the one or more predictive models comprises providing data from the one or more predictive models to a dynamic desalter model.

18. The method of claim 17, wherein the dynamic desalter model predicts performance of or controls a desalter that comprises a portion of the refining process.

19. (canceled)

20. The method of claim 1, further comprising receiving, from the refining process, process data as the hydrocarbon moves through the refining process, wherein the process data is used to refine and update the developed one or more predictive models of the hydrocarbon refining process for the hydrocarbon entering the refining process based on the analysis of the hydrocarbon sample.

21. (canceled)

22. The method of claim 20, wherein aspects of the hydrocarbon refining process as the hydrocarbon entering the refining process moves through the refining process are dynamically controlled based on the refined and updated one or more predictive models.

23. The method of claim 22, wherein dynamically controlling aspects of the hydrocarbon refining process as the hydrocarbon entering the refining process moves through the refining process based on the one or more predictive models comprises dynamically controlling the hydrocarbon refining process to mitigate creation of hydrochloric acid in the refining process.

24. (canceled)

25. A system for dynamically using predictive analytics in control of a hydrocarbon refining process comprising:
a memory, wherein the memory stores computer-readable instructions; and
a processor communicatively coupled with the memory, wherein the processor executes the computer-readable instructions stored on the memory, the computer-readable instructions causing the processor to:
receive an analysis of a hydrocarbon sample, wherein the hydrocarbon sample is representative of an amount of hydrocarbon entering a refining process;
develop one or more predictive models of the hydrocarbon refining process for the hydrocarbon entering the refining process based on the analysis of the hydrocarbon sample; and
dynamically control aspects of the hydrocarbon refining process as the hydrocarbon entering the refining process moves through the refining process based on the one or more predictive models.

26. The system of claim 25, wherein analyzing the hydrocarbon sample comprises obtaining a fingerprint of the hydrocarbon sample using spectroscopy, wherein the spectroscopy comprises one or more of infrared spectroscopy, near-infrared spectroscopy, and nuclear magnetic resonance spectroscopy.

27. (canceled)

28. (canceled)

29. The system of claim 25, wherein developing one or more predictive models of the hydrocarbon refining process for the hydrocarbon entering the refining process based on the analysis of the hydrocarbon sample comprises developing one or more predictive models based on the fingerprint that estimate or predict one or more of density, viscosity, total acid number (TAN), percent saturates, percent asphaltenes, percent resins, percent aromatics, asphaltene stability, crude stabilizer (CS) dosage demand, emulsion stability and demulsifier (EB) dosage demand, fouling potential and antifoulant (AF) dosage demand, and corrosion related performance and corrosion inhibitor dosage demand during the hydrocarbon refining process.

30. The system of claim 25, wherein the one or more predictive models comprise one or more of a crude markers model, a crude compatibility/instability model, an emulsion tendency model, and a fouling potential model.

31. The system of claim 30, wherein a crude stabilizer dose is determined from the instability model, wherein the crude stabilizer dose is added to a hydrocarbon storage tank farm that holds the hydrocarbon entering the refining process, wherein the crude stabilizer dose comprises an injection of one or more stabilizing chemicals to the crude in the incoming transport system or to crude storage tanks.

32. (canceled)

33. (canceled)

34. The system of claim 30, wherein an emulsion breaker dose is determined from the emulsion tendency model, wherein the emulsion breaker dose is added to a hydrocarbon storage tank farm that holds the hydrocarbon entering the refining process and wherein the emulsion breaker dose comprises the injection of one or more demulsification and wetting agents chemicals to the crude in the incoming transport system and/or to crude in tankage, and/or to the water wash and to the desalter.

35. (canceled)

36. (canceled)

37. The system of claim 30, wherein an antifoulant dose is determined from the fouling potential model, wherein the antifoulant dose is added to a hot preheat train after desalting of the refining process and wherein the antifoulant dose comprises the injection of dispersants, stabilizers, polymerization inhibitors and metal coordinators.

38. (canceled)

39. (canceled)

40. The system of claim 25, wherein dynamically controlling aspects of the hydrocarbon refining process as the hydrocarbon entering the refining process moves through the refining process based on the one or more predictive models comprises providing advisory information from the one or more predictive models to person regarding the operation of the refining process or a portion of the refining process.

41. The system of claim 25, wherein dynamically controlling aspects of the crude refining process as the hydrocarbon entering the refining process moves through the refining process based on the one or more predictive models comprises providing data from the one or more predictive models to a dynamic desalter model.

42. The system of claim 41, wherein the dynamic desalter model predicts performance of a desalter that comprises a portion of the refining process or wherein the dynamic desalter model controls a desalter that comprises a portion of the refining process.

43. (canceled)

44. The system of claim 25, further comprising one or more sensors that monitor the refining process, wherein the processor receives process data from the refining process as the hydrocarbon moves through the refining process.

45. The system of claim 44, wherein the process data is used to refine and update the developed one or more predictive models of the hydrocarbon refining process for the hydrocarbon entering the refining process based on the analysis of the hydrocarbon sample and wherein aspects of the hydrocarbon refining process as the hydrocarbon entering the refining process moves through the refining process are dynamically controlled based on the refined and updated one or more predictive models.

46. (canceled)

47. The system of claim 45, wherein dynamically controlling aspects of the hydrocarbon refining process as the hydrocarbon entering the refining process moves through the refining process based on the one or more predictive models comprises dynamically controlling the hydrocarbon refining process to mitigate creation of hydrochloric acid in the refining process.

48. The system of claim 25, wherein the refining process comprises a tank farm, a cold preheat train, a desalter, a hot preheat train, a crude heater/furnace, a crude distillation unit, a vacuum unit furnace, a vacuum distillation unit, and downstream processing units.
